(19) United States
(12) Patent Application Publication
(10) Pub. No.: US 2022/0270025 A1
(43) Pub. Date: Aug. 25, 2022

(54) Employee Scheduler

(71) Applicant: Isom IP, LLC, Henderson, NV (US)

(72) Inventors: Justin Elliott Isom, Henderson, NV (US); Naysha Mya Isom, Henderson, NV (US)

(21) Appl. No.: 17/676,983

(22) Filed: Feb. 22, 2022

Related U.S. Application Data
(60) Provisional application No. 63/200,222, filed on Feb. 23, 2021.

(51) Int. Cl. G06Q 10/06

(52) U.S. Cl. CPC G06Q 10/063116; G06Q 10/063112; G06Q 10/063118

(57) ABSTRACT

An employee scheduling system provides a primary work schedule and a standby work schedule based on assignment of workers to teams and subteams. The scheduling system automatically assigns works to shifts based on user inputs, such as design constraints. The output schedule is displayed to a user on the graphical user interface of an output device, including the standby work schedule indicating subteam assignments to off-days.

### CROSS REFERENCE TO RELATED APPLICATION

This application claims the benefit of U.S. Provisional Application No. U.S. 63/200,222 filed Feb. 23, 2021, which is hereby incorporated in its entirety.

### TECHNICAL FIELD

The present invention pertains generally to the field of scheduling systems for displaying and modifying worker schedules.

### BACKGROUND OF THE INVENTION

There is a long felt need for a method to assign workers to work schedules that is equitable, fair, and predictable. There is further a long felt need for a method to assign workers to work schedules that provides adequate coverage of work shifts without incurring undue overtime costs or asking workers to work too many days in a row. There is further a long felt need for a graphical user interface to quickly assess whether or not a method for assigning workers to work schedules meets the above-mentioned criteria.

### BRIEF SUMMARY OF THE EMBODIMENTS

Embodiments disclosed herein are directed to an employee scheduling system which provides a primary work schedule and a standby work schedule based on assignment of workers to teams and subteams. The scheduling system automatically assigns workers to shifts based on user inputs, such as design constraints. The output schedule is displayed to a user on the graphical user interface of an output device, including the standby work schedule indicating subteam assignments to off-days. Examples are provided of schedule outputs that are equitable to the workers, fair to the workers, and predictable for the workers.

According to one or more embodiments, a scheduling system for providing a work schedule for workers in a workforce includes:

a) an input device configured to receive an input;

b) an output device configured to provide output to a user in graphical form, on an attached graphical user interface;

c) a digital processor; and

d) a permanent memory comprising computer readable instructions configured to physically cause the digital processor to carry out steps comprising:
i) receiving, by the input device, a list of workers qualified to perform one or more work tasks during a work shift;
ii) counting a number of work shifts to be performed in a day by the workforce;
iii) determining a number of the workers to be assigned to the workforce, wherein the number of workers is twice the number of work shifts;
iv) assigning each of the workers in the workforce to one of two work teams, wherein each of the two work teams has about the same number of workers;
v) dividing each of the two work teams into a number of subteams, wherein the number of subteams is a multiple of a number of off-days in a work period of a work cycle;
vi) assigning the workers of the two work teams into the subteams, wherein each of the subteams has about the same number of the workers;
vii) assigning the two work teams to alternating primary work schedules of on-days and off-days within the work period;
viii) dividing the work cycle into standby cycles wherein each of the standby cycles is an integral number of work periods long;
ix) determining, for each standby cycle in the work cycle, an initial subteam number;
x) for each work team and for each standby cycle in the work cycle, assigning one of the subteams to each off-day in a given standby cycle, based on the input received in (a); and
xi) displaying, on the graphical user interface of the output device, an indication of the subteam assignments to the off-days.

According to one or more embodiments, the scheduling system further includes, in the steps of (d):

in (x), assigning one of the subteams to each off-day by steps including:
setting a first subteam number equal to the initial subteam number for the given standby cycle;
increasing the first subteam number by an increment for each subsequent off-day in the given standby cycle;
when the first subteam number is greater than the number of subteams, decreasing the first subteam number by the number of subteams;
assigning the subteams to the off-days of the given standby cycle according to the first subteam numbers; and
wherein the initial subteam number and the increment are based on the input received in (a).

According to one or more embodiments, the scheduling system further includes, in the steps of (d):

in (ix), determining the initial subteam number by steps including:
setting the initial subteam number equal to one for a first standby cycle;
increasing the initial subteam number by an index for each subsequent standby cycle; and
when the initial subteam number is greater than the number of subteams, decreasing the initial subteam number by the number of subteams.

According to one or more embodiments of the scheduling system, the input of (a) includes one or more of: a design goal, a relationship between multiple design goals, a design constraint, and a relationship between multiple design constraints.

According to one or more embodiments of the scheduling system, the input of (a) includes one or more design goals selected from the group consisting of: assigning about the same number of work hours for each worker during a work period, assigning each worker an equal number of on-days for a particular day of the week over the work cycle, and assigning each worker an equal number of off-days for a particular day of the week over the work cycle.

According to one or more embodiments of the scheduling system, the input of (a) includes one or more design constraints selected from the group consisting of: a coverage quota, an overtime limit, and a contiguity limit.

According to one or more embodiments of the scheduling system, the indication of the subteam assignments to the off-days is displayed on the graphical user interface of the output device in a calendar format.

According to one or more embodiments of the scheduling system, the graphical user interface is configurable to alternately display the indication of the subteam assignments to the off-days for (i) all subteams and (ii) a single subteam.

According to one or more embodiments of the scheduling system, the number of subteams of each work team is six or seven.

According to one or more embodiments of the scheduling system, the work period is selected from the group consisting of: a week, a biweek, a semi-month, and a month.

According to one or more embodiments of the scheduling system, the workers are assigned to work teams and subteams by substantially evenly distributing workers that share a demographic factor among the work teams and the subteams.

According to one or more embodiments of the scheduling system, the steps of (d) further include: detecting, by the processor, when a contiguity limit is met.

According to one or more embodiments of the scheduling system, the displayed subteam assignments are configured to allow visual verification of a design goal.

According to one or more embodiments of the scheduling system, the displayed subteam assignments are configured to allow visual verification of a design constraint.

These and other aspects of the embodiments will be better appreciated and understood when considered in conjunction with the following description and the accompanying drawings. The following description, while indicating various embodiments and details thereof, is given by way of illustration and not of limitation. Many substitutions, modifications, additions, or rearrangements may be made within the scope of the embodiments, and the embodiments may include all such substitutions, modifications, additions, or rearrangements.

### BRIEF DESCRIPTION OF THE DRAWINGS

Non-limiting and non-exhaustive embodiments of the employee scheduler are described with reference to the following figures, wherein like reference numerals refer to like parts throughout the various views unless otherwise specified.

FIG. 1 is a schematic diagram of an embodiment of a scheduling system.

FIG. 2 is a diagram of an embodiment of a graphical user interface of an output device.

FIG. 3 is a flow chart of a method for providing a work schedule.

FIG. 4 is a flow chart of a work team and subteam schedule method.

FIG. 5 is a flow chart of a method of standby worker assignment.

FIG. 6 is a graphical output of a primary and standby workday calendar where there is one biweek per standby cycle.

FIG. 7 is a graphical output of a primary and standby workday calendar where there are two biweeks per standby cycle.

FIG. 8 is a graph of unscheduled absences of workers in a workforce.

FIG. 9 is a diagram of schedule design goals.

FIG. 10 is a diagram of schedule design constraints.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. Also, common but well-understood elements that are useful or necessary in a commercially feasible embodiment are often not depicted in order to facilitate a less obstructed view of these various embodiments.

### DETAILED DESCRIPTION OF THE INVENTION

The detailed description describes non-limiting exemplary embodiments. Any individual features may be combined with other features as required by different applications for at least the benefits described herein.

As used herein, the term “about” means plus or minus 10% of a given value unless specifically indicated otherwise. “About” may also mean plus or minus 1 of a given integer value. For example, as described in more detail below, if 39 workers are assigned to 7 subteams, then the individual subteams may have 5, 5, 5, 6, 6, 6, 6 members respectively. The number of members of each subteam, therefore, is about the same.

As used herein, relative orientation terms, such as “up”, “down”, “top”, “bottom”, “left”, “right”, “vertical”, “horizontal”, “distal” and “proximal” are defined with respect to an initial presentation of an object and will continue to refer to the same portion of an object even if the object is subsequently presented with an alternative orientation, unless otherwise noted.

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

As used herein, a “computer-based system” comprises an input device for receiving data, an output device for outputting data in tangible form (e.g., printing or displaying on a computer screen), a permanent memory for storing data as well as computer code, and a digital processor for executing computer code. Said computer code resident in said permanent memory will physically cause said digital processor to read-in data via said input device, process said data within said digital processor and output said processed data via said output device. An example of a digital processor is a microprocessor. An example of a computer-based system is a graphical user interface.

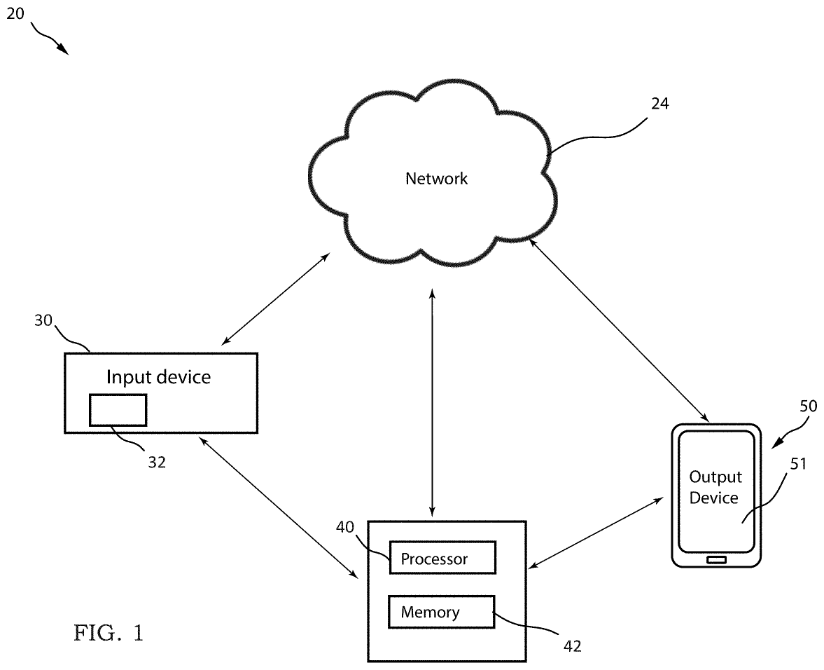

FIG. 1 is a schematic diagram of an embodiment of a scheduling system, generally referred to as 20. System 20 includes an input device 30 configured to receive an input 32 (for example, input device 30 may be a desktop computer which may receive input directly from a user; input device 30 may be a networked computer which may receive input from a user in communication with a network 24 (e.g., through a web interface).

Input device 30 is in communication with a digital processor 40 and a permanent memory 42. Digital processor 40 and permanent memory 42 are also in communication with an output device 50, such as tablet, smartphone, personal computer, or similar. Output device 50 is configured to provide output to a user on an attached graphical user interface, such as a display 51.

As illustrated, input device 30, digital processor 40, permanent memory 42, and output device 50 may communicate directly with one another or may communicate via a network interface, such as network 24. In other cases, more than one of input device 30, digital processor 40, permanent memory 42, and output device 50 may be present in the same physical device.

An input 32 may include one or more of: a design goal, a relationship between multiple design goals, a design constraint, and a relationship between multiple design constraints. Examples of design goals include that the schedule be equitable to the workers, fair to the workers and predictable for the workers. Additional goals may be provided depending upon the particular requirements of a work task. As used herein, “equitable” means that a worker is treated uniformly over time. An example of equity is that the worker is assigned an equal number of work hours for each work period (e.g., a pay period). A work period may for example be a biweek. As used herein, “fair” means that each worker is treated the same as the other workers. An example of fairness is that each worker will be assigned an equal number of the same days of the week over a work cycle. For example, each worker may be assigned to two standby shifts on a Sunday, Monday, Tuesday, etc. over a work cycle. As used herein, “predictable” means that a worker will be able to readily perceive when said worker will work either a primary shift or a standby shift. An example of a predictable primary work schedule is for a worker to work two days on and two days off.

Additional examples of input 32 include a rotation pattern of on-days and/or off-days (e.g., 1-2-2-1-1-2-2-1 is a rotation pattern indicating on-days for teams 1 and 2); a pattern start date; days off (e.g., Sunday); and holidays.

Examples of design constraints may include adequate coverage, coverage quotas, low overtime, overtime limits, and contiguity limits. As used herein, “coverage” means that all work shifts in a given day are covered by qualified workers. An example of inadequate coverage would be if a work shift was not covered and either a supervisor had to cover the shift or the work shift was not done. An example of a coverage quota may be maintaining a specific percentage (e.g., 95%) of covered work shifts in the work cycle. As used herein, “overtime” means that no workers are scheduled to work more than a standard number of hours in a pay period. A typical pay period is a biweek. A typical number of hours that can be worked in a biweek without incurring overtime is 80. An example of an overtime limit may be that no specific employee may exceed 8 hours of overtime in a month. As used herein, “contiguity” means that no worker is allowed to work more than a maximum number of shifts in a row. For example, workers that drive delivery trucks might not be allowed to work more than six days in a row.

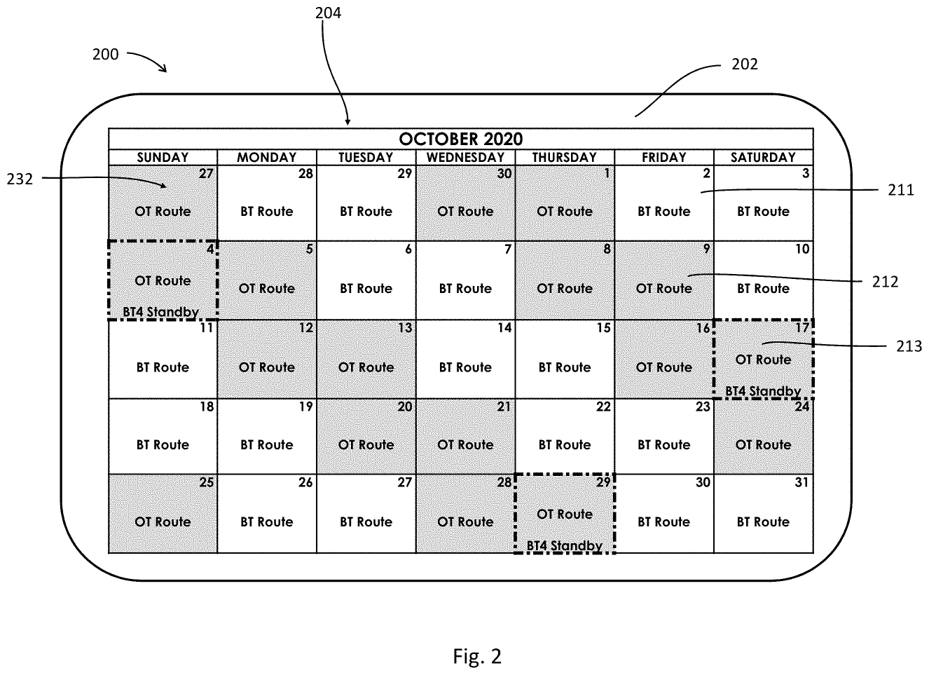

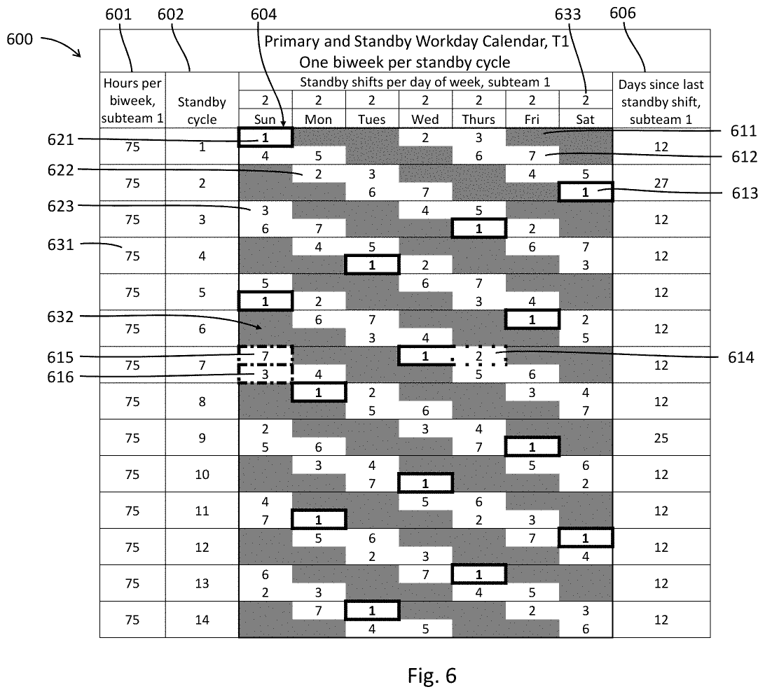

FIG. 2 is a diagram of an embodiment of an output device 200 with an attached graphical user interface 202. Graphical user interface 202 displays a schedule in a calendar format 204. The content of this display is discussed in more detail in relation to FIG. 6.

### Schedule Setup

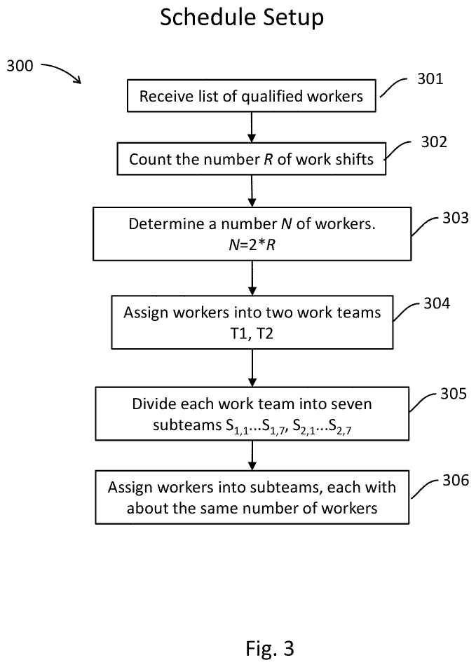

FIG. 3 is a flow chart 300 of a schedule setup method. The setup method may comprise the steps:

i) receive 301 by an input device, a list of workers qualified to perform one or more work tasks during a work shift;

ii) count 302 a number of work shifts R to be performed in a day by a workforce;

iii) determine 303 a number N of the workers to be assigned to said workforce equal to 2*R;

iv) assign 304 said workers in the workforce to a first work team T1 and a second work team T2 wherein each of the work teams has about the same number of workers;

v) divide 305 each of the work teams into seven subteams, S1,2 . . . S1,7, S2,1 . . . S2,7; and

vi) assign 306 the workers of the work teams into the subteams wherein each of the subteams has about the same number of the workers.

The workforce is divided into two work teams so that one work team can be assigned to the R work shifts of a given work day and a subteam of the other work team can serve as a backup in case one or more workers in the first work team are absent. It has been surprisingly found that for certain kinds of work tasks, such as driving delivery trucks, that subteams with 1/7 the number of work shifts provides adequate backup coverage for the typical number of unscheduled worker absences experienced.

Workers may be assigned to work teams and subteams based on different factors. One method is to randomly assign workers. An alternative method is to balance the demographics of the members of each subteam, e.g., by substantially evenly distributing workers that share a demographic factor among the work teams and the subteams. Demographic factors might be age, gender, experience, etc.

### Work Team and Subteam Schedule Method

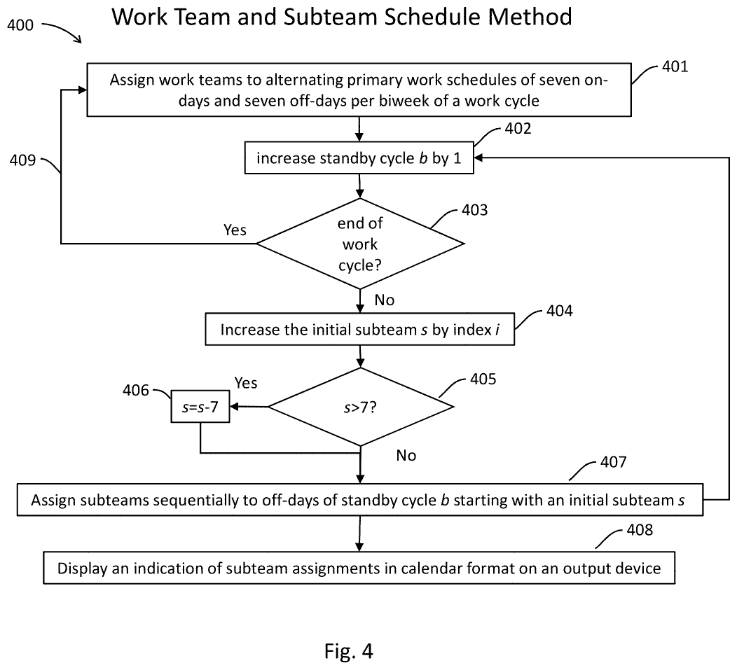

FIG. 4 is a flow chart 400 of a work team and subteam schedule method. Not all steps are illustrated for clarity and simplicity. The method may comprise the steps:

i) assign 401 work teams to alternating primary work schedules of seven on-days and seven off-days per biweek of a work cycle;

ii) divide the work cycle into standby cycles wherein each of the standby cycles is an integral number of biweeks long;

iii) for each standby cycle 402 in the work cycle 403, determine an initial subteam number by steps comprising:
1) set the initial subteam number equal to 1 for standby cycle 1;
2) increase 404 the initial subteam number by an index i for each subsequent standby cycle; and
3) when 405 the initial subteam number is greater than 7, decrease 406 the initial subteam number by 7;

iv) for each work team and for each standby cycle in the work cycle, assign 407 a subteam to each off-day in a given standby cycle by steps comprising:
1) set a first subteam number equal to the initial subteam number for the given standby cycle;
2) increase the first subteam number by 1 for each subsequent off-day in the given standby cycle;
3) when the first subteam number is greater than 7, decrease the first subteam number by 7; and
4) assign the subteams to the off-days of the given standby cycle according to the first subteam numbers; and

v) display 408 an indication of the subteam assignments to the off-days in a calendar format on the output device.

The process may be repeated 409 for each subsequent work cycle.

A shift where all members of a given work team are assigned to work is called a primary work shift for that given work team. The schedule of the primary work shifts of a given work team is a primary work schedule. In the example described below regarding delivery drivers, each work shift is 10 hours long and there is one work shift per day. A primary work day for one work team is a standby work day for a subteam of the other work team. If there are seven primary work days for a given work team in a biweek, then there are seven off-days for the given work team in the same biweek. This assumes that the work days are seven days a week. If the total number of work days in a biweek were different, such as 12 (i.e., 6 days a week), then the methods described herein could be modified to provide a different number of subteams per work team, such as six. To achieve the goal of equity, the number of subteams may be a multiple of the number of off-days in a biweek or other standard work period or pay period, such as a week, a semi-month, or a month. As used herein, “multiple” means the result of multiplying a number by an integer (not by a fraction). For example, if a schedule has six off-days per work period the number of subteams should be a multiple of six (6, 12, 18, etc.).

An equitable, fair, and predictable method of assigning primary work days to a given work team is to assign two days on and two days off. For one 10-hour shift per work day, each worker will have 70 primary work day hours in a biweek. This is less than 80 hours, so there is no scheduled overtime. No worker is scheduled for more than two primary work days in a row, so there is no problem with contiguity. Since the work teams alternate, all days have an adequate number of workers assigned to them so there is good coverage.

An alternate equitable, fair, and predictable method for assigning primary work days to a given work team is to assign one day on and one day off. The methods described herein for assigning subteams to off days will apply to this method of assigning work teams to primary work days.

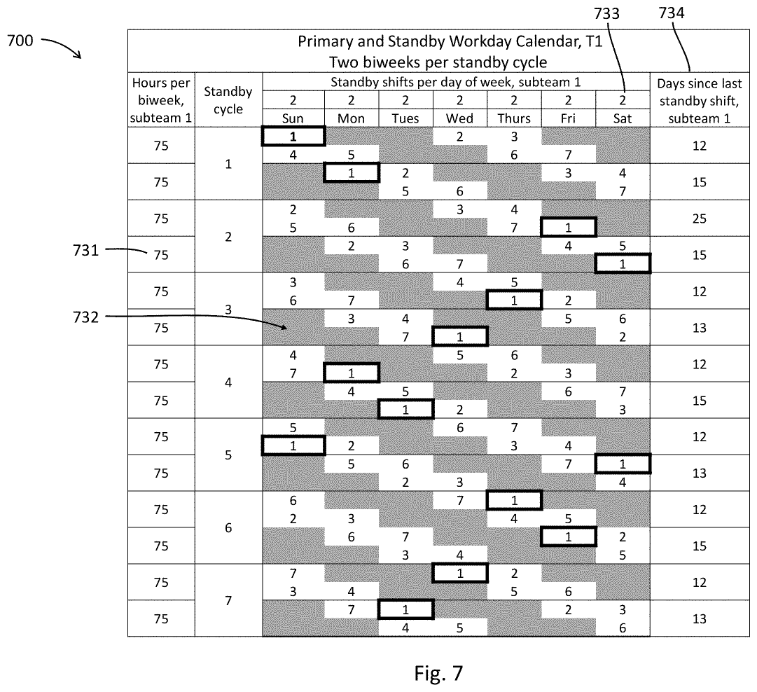

The seven subteams can each be assigned to one of the seven off-days for their work team during a biweek. The workers in these subteams will be available if one or more primary workers has an unscheduled absence (e.g., a sick day). The subteams can be assigned sequentially to each off-day in a biweek. The initial subteam assigned to a first off-day of a biweek can be rotated for each subsequent biweek so that all subteams will take an equal number of turns being assigned to a given day of the week. This will be described in more detail below with respect to FIGS. 6 and 7. The index number i of each rotation can be an integer between 1 and 6 inclusive. An advantage of using an index of 1 is the rotation of subteams is more predictable and more easily confirmed when viewed in a calendar format.

The number of weeks it takes for all subteams to rotate through their assignments is defined as a work cycle. Once a work cycle is complete the process begins over again. When there are two work teams and 7 subteams per work team, a work cycle is 28 weeks long.

### Standby Worker Assignment

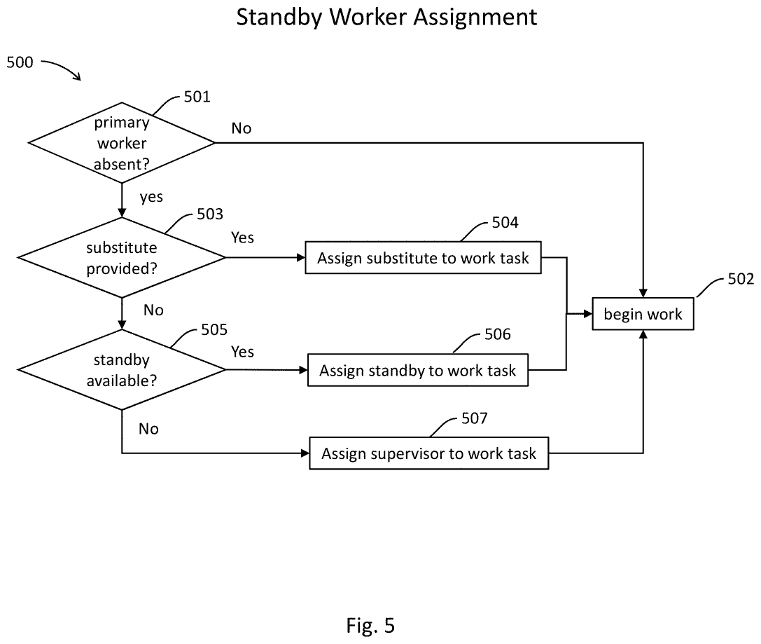

FIG. 5 is a flow chart 500 of a method of standby worker assignment. At the beginning of each work shift, attendance is taken to determine 501 if a primary worker is absent. If no primary worker is absent, then the workers begin work 502 (e.g., drivers are dispatched to their delivery routes).

If there is a primary worker absent, then it is determined 503 if a substitute worker has been scheduled. For example, if a primary worker knows they can't be there, the primary worker may call up a worker on the other work team and arrange for the other worker to be a scheduled substitute. If a substitute is provided, the substitute is assigned 504 to the work task and work begins 502.

If no substitute is provided (i.e., an unscheduled absence), then it is determined 505 if a standby worker from the subteam assigned to that work day is available. If so, then the standby worker is assigned 506 to the absent worker's task and work begins 502.

If no standby worker is available (e.g., the total number of unscheduled absences exceeds the number of standby workers on the subteam), then a supervisor may be assigned 507 to the work task and work begins. This may be an expensive way to have the work done and is to be avoided. Alternatively, the work task may not be done (e.g., a particular delivery route may not be driven that day). This also may be expensive in terms of lost revenue or possible penalties from a customer. It is important, therefore, to have a suitably low percentage of days where the number of unscheduled absences exceeds the number of standby workers in a subteam. A suitably low number might be 2% or less.

### Primary and Standby Workday Calendar

FIG. 6 is a graphical output 600 of a primary and standby workday calendar for a first work team T1. The calendar is based on one biweek per standby cycle. This output, or a portion thereof, may be provided to a user on a screen of a computer system, such as an output device 50 (see FIG. 1).

The output may comprise a calendar 604 showing days of week horizontally and weeks of a work cycle vertically. Each primary work day (e.g., 611) for a given work team (e.g., work team T1) may be shown with a dark fill. Each standby work day (e.g., 612) may be shown with a light fill and a number displayed thereupon. The number may indicate which subteam of the work team is assigned to the standby day (e.g., subteam 7 for standby day 612). Days (e.g., 613) where a particular subteam (e.g., subteam 1) is assigned to a standby day may be highlighted so that a user can quickly see visually how the subteam is assigned.

Alternate shading may be provided to days 614 where a substitute has been scheduled for a primary worker. This might be presented on a worker's individual calendar so the worker can see when the worker should show up to be a substitute (see discussion of FIG. 2, below). Similar shading may be provided on a supervisor's calendar with a popup provided (not shown) to indicate what worker is substituting that day. In embodiments, the graphical user interface is configurable to alternately display the indication of the subteam assignments to the off-days for (i) all subteams and (ii) a single subteam. In this manner, the interface may alternate (e.g., by a selection input by a user) between a display suited for an individual worker or a display suited for a supervisor.

The system can be configured to detect limits of contiguity (e.g., no more than 6 work days in a row) and may indicate days 615, 616 that are no longer available for a worker to work once the worker has been scheduled for one or more substitute days. The system may be configured to count a standby day as a day worked to make sure contiguity is not violated should the worker be assigned to a full shift on the standby day.

In this example, each standby cycle 602 is one biweek. The index i is 1. Thus, when subteam 1 is assigned to the first standby day 621 of the first standby cycle, subteam 2 will be assigned to the first standby day 622 of the second standby cycle. Subteam 3 will be assigned to the first standby day 623 of the third standby cycle and so on.

The pattern 632 of primary work days and standby work days repeats after 14 standby cycles (i.e., 28 weeks). The primary workday pattern and subteam standby day pattern is readily apparent. Thus, it is clear that the schedule is equitable (e.g., same work hours per biweek), fair (e.g., all workers have the same number of primary work days and standby work days for each day of the week) and predictable (e.g., the pattern of primary work days and standby work days is readily apparent).

Numerical statistics may be provided and automatically calculated for the graphical output. The statistics may include the scheduled hours per biweek 601 a given subteam works, the number of standby shifts 633 worked by a given subteam for each day of the week, and the days 606 since a given subteam worked a prior standby shift.

In the example provided, the number of scheduled hours per biweek 631 for a given subteam (e.g., subteam 1) includes an estimate of the average number of hours a worker will work on a standby day. This may include a fixed number of hours each standby worker gets paid for showing up (e.g., 2 hours) plus the average number of hours a worker will work due to assignment to a work task of an unscheduled absence of a primary worker (e.g., 30% chance of assignment times 10 hours=3 hours on average).

The assignment of standby workers to fill unscheduled absences may be rotated so that each standby worker will, over time, have the same number of full workdays due to assignment to replace unscheduled absences. An example of such a rotation is provided in steps 402-406 of the method of FIG. 4.

In this example, each worker is scheduled for one standby shift per biweek. This adds 5 hours on average to the 70 hours of primary work shift time.

Referring again to the embodiment of FIG. 2, calendar 204 shows a one month view of a worker's individual calendar. In this example, there are two work teams, orange (OT) and blue (BT). Each work team is divided into seven subteams. Calendar 204 is for a worker on the fourth subteam of the blue work team, also referred to as subteam BT4. Each primary work day (e.g., 211) for the blue work team (e.g., work team BT) is shown with a light fill. Each off-day for the worker (e.g., 212) may be shown with a dark fill. Days (e.g., 213) where the individual worker's subteam (e.g., subteam BT4) is assigned to a standby day may be differently marked (e.g., with a bold outline as shown, or with a different color) so that the worker can quickly see visually their specific standby days for the month. In this view, standby days for other subteams (e.g., BT1, BT2, etc.) are not shown. The pattern 232 of primary work days and standby work days is readily apparent. Thus, it is clear that the schedule is equitable (e.g., same work hours per biweek), fair (e.g., standby days are scheduled for different days of the week), and predictable (e.g., the pattern of primary work days and standby work days is readily apparent).

FIG. 7 is a graphical output 700 of a primary and standby workday calendar when there are two biweeks per standby cycle. The index i is 1 in this example, but the index may be any integer between 1 and the number of subteams. For example, if a work cycle corresponds to a calendar year, it may be desirable to shift, or otherwise change, the index between work cycles so that the same subteam does not have similar standby assignments from year to year. The pattern 732 of primary work days is the same as the example of FIG. 6. The pattern of subteam assignments to standby days is different than when there was one biweek per standby cycle, but the pattern is still readily apparent and predictable. The number of hours (e.g., 731) per biweek is the same. The number of standby shifts (e.g., 733) per workday is also the same for each day of the week. The number of days 734 since the last standby shift for each subteam is somewhat different than when there was one biweek per standby cycle, but it is still equitable.

### EXAMPLE 1

A delivery company had 39 delivery routes to service every day of the week, seven days a week. Qualified driver associates (e.g., associates with valid driver's licenses) were assigned each day to drive (i.e., the work task) said routes. The number of driver associates hired was 78 (i.e., twice the number of routes). The driver associates were divided into a first work team and a second work team. The work teams were assigned to alternating primary work schedules of two days on and two days off. Each work team was divided into seven subteams. The subteams had 5, 5, 5, 6, 6, 6, and 6 workers assigned to each respectively. A work cycle of 28 weeks was established. The work cycle was divided into 7 standby cycles of two biweeks each. The index i was set at 1. The assignment of standby teams to standby days is shown in FIG. 7. The schedule was run for six months with a record kept of daily unscheduled absences.

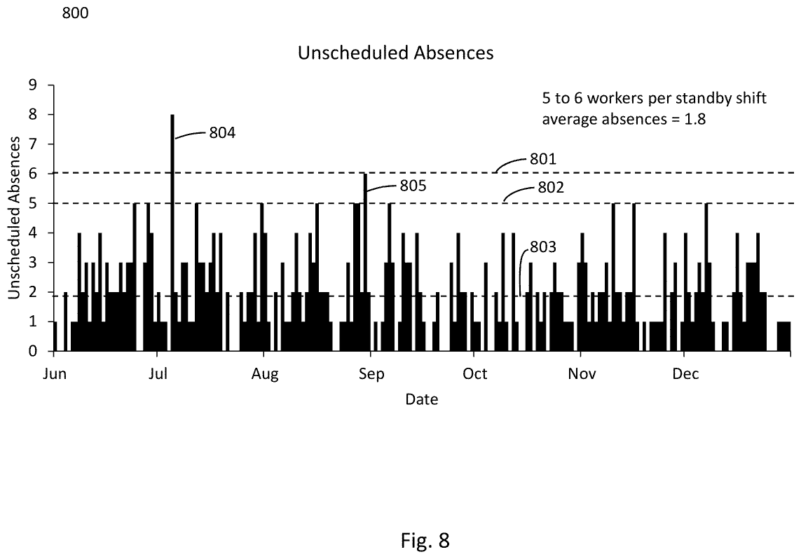

FIG. 8 is a graph 800 of the unscheduled absences observed over six months (i.e., 213 days). The number of daily unscheduled absences ranged from 0 to 8. There were only two days 804, 805, out of 213 days where the number of unscheduled absences exceeded the number of standby workers available. On the first day 804, there were 8 unscheduled absences and 6 standby workers available 801. Two supervisors, therefore, had to drive routes. On the second day 805, there were 6 unscheduled absences and only 5 standby workers available 802 so one supervisor had to drive a route. Only about 1% of the workdays, therefore, required a supervisor to drive a route. Thus, the system achieved a suitable level of coverage.

The average number of unscheduled absences 803 was 1.8 per day. This added an average of 3.3 hours to the 2 hours each worker was paid per biweek for working a standby shift. This validates the estimate in FIGS. 6 and 7 of an average of 5 additional hours per worker per biweek for working standby shifts.

The system was well received by the workers. Worker turnover decreased once the system was implemented in part due to the equity, fairness, and predictability of the system.

### Schedule Design Goals

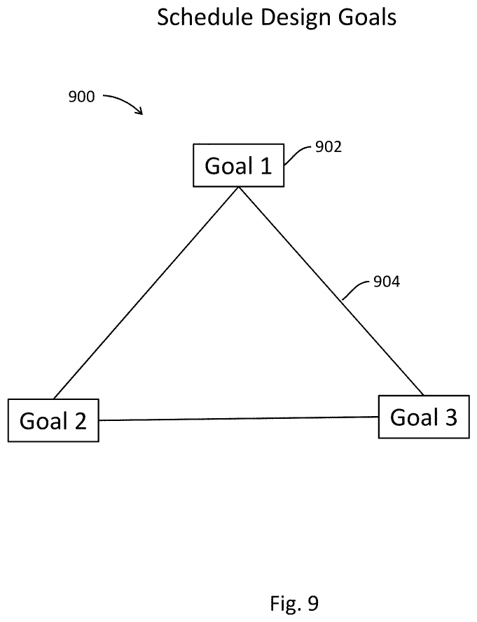

FIG. 9 is a diagram 900 of schedule design goals (e.g., 902) for workers. The three design goals illustrated, goal 1, goal 2, and goal 3, may include that the schedule be equitable to the workers, fair to the workers, and predictable for the workers. Additional goals may be provided depending upon the particular requirements of a work task.

There may be relationships 904 between the goals, (e.g., tradeoffs). For example, a schedule where one worker always works a standby shift on a Sunday and another worker always works a standby shift on a Monday, may be predictable, but it would not be fair. A method for scheduling, therefore, would seek to balance tradeoffs between different goals.

### Schedule Design Constraints

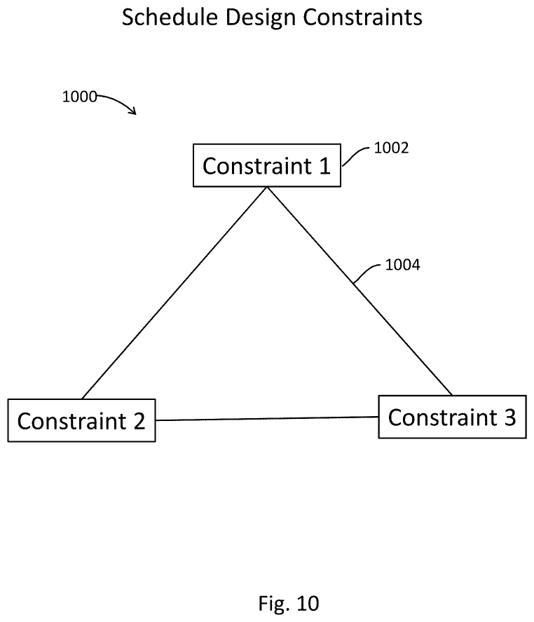

FIG. 10 is a diagram 1000 of schedule design constraints (e.g., 1002). The design constraints (e.g., constraint 1, constraint 2, constraint 3) may include adequate coverage, a coverage quota, low overtime, an overtime limit, and contiguity limits.

There may be relationships 1004 (e.g, tradeoffs) between constraints. For example, a first worker may wish to substitute for a second worker that cannot work their primary shift, but the first worker has already worked 6 days in a row. This would create a tradeoff between coverage and contiguity. A method for scheduling workers, therefore, would seek to minimize tradeoffs between schedule design constraints.

In order to achieve these goals without violating these constraints, a scheduling system may be provided to automatically assign workers to shifts and to display the assignment such that a user can immediately verify the achievement of the goals without a violation of the constraints.

While the disclosure has been described with reference to one or more different exemplary embodiments, it will be understood by those skilled in the art that various changes may be made and equivalents may be substituted for elements thereof without departing from the scope of the disclosure. For example, the scheduling methods described herein may be applied to product production such as bakery production runs. A bakery may be set up to run 2 days of one main product (e.g., Blueberry Muffins) followed by 2 days of another main product (e.g., Orange cakes). Each primary production may have 7 sub items (e.g., vanilla icing, chocolate icing, strawberry icing, etc.). Each of the 7 sub items of one product may serve as a “backup” or standby on a particular day when the other main product is in production.

Another example of an alternative embodiment might be drinking glasses. One main product might be base white drinking glasses and the other main product might be base black drinking glasses. The subteams would be different accessorized versions of the base color glasses. A retailer could display the base colors and the accessorized versions would be on standby and could easily be swapped into the rotation for the day if a base color is sold or broken, or the retailer merely wanted to exchange a base color for an accessorized version on a given day. Whenever the retailer sold any item, it would merely create (“hire”) a new base color.

The embodiments of the employee scheduler and methods of use described herein are exemplary and numerous modifications, combinations, variations, and rearrangements can be readily envisioned to achieve an equivalent result, all of which are intended to be embraced within the scope of the appended claims. Further, nothing in the above-provided discussions of the employee scheduler and methods of use should be construed as limiting the invention to a particular embodiment or combination of embodiments. The scope of the invention is defined by the appended claims.

We claim:

1. A scheduling system for providing a work schedule for workers in a workforce, the scheduling system comprising:
a) an input device configured to receive an input;
b) an output device configured to provide output to a user in graphical form, on an attached graphical user interface;
c) a digital processor; and
d) a permanent memory comprising computer readable instructions configured to physically cause the digital processor to carry out steps comprising:
i) receiving, by the input device, a list of workers qualified to perform one or more work tasks during a work shift;
ii) counting a number of work shifts to be performed in a day by the workforce;
iii) determining a number of the workers to be assigned to the workforce, wherein the number of workers is twice the number of work shifts;
iv) assigning each of the workers in the workforce to one of two work teams, wherein each of the two work teams has about the same number of workers;
v) dividing each of the two work teams into a number of subteams, wherein the number of subteams is a multiple of a number of off-days in a work period of a work cycle;
vi) assigning the workers of the two work teams into the subteams, wherein each of the subteams has about the same number of the workers;
vii) assigning the two work teams to alternating primary work schedules of on-days and off-days within the work period;
viii) dividing the work cycle into standby cycles wherein each of the standby cycles is an integral number of work periods long;
ix) determining, for each standby cycle in the work cycle, an initial subteam number;
x) for each work team and for each standby cycle in the work cycle, assigning one of the subteams to each off-day in a given standby cycle, based on the input received in (a); and
xi) displaying, on the graphical user interface of the output device, an indication of the subteam assignments to the off-days.

2. The scheduling system of claim 1, the steps of (d) further comprising:
in (x), assigning one of the subteams to each off-day by steps comprising:
setting a first subteam number equal to the initial subteam number for the given standby cycle;
increasing the first subteam number by an increment for each subsequent off-day in the given standby cycle;
when the first subteam number is greater than the number of subteams, decreasing the first subteam number by the number of subteams;
assigning the subteams to the off-days of the given standby cycle according to the first subteam numbers; and
wherein the initial subteam number and the increment are based on the input received in (a).

3. The scheduling system of claim 1, the steps of (d) further comprising:
in (ix), determining the initial subteam number by steps comprising:
setting the initial subteam number equal to one for a first standby cycle;
increasing the initial subteam number by an index for each subsequent standby cycle; and
when the initial subteam number is greater than the number of subteams, decreasing the initial subteam number by the number of subteams.

4. The scheduling system of claim 1, wherein the input of (a) includes one or more of: a design goal, a relationship between multiple design goals, a design constraint, and a relationship between multiple design constraints.

5. The scheduling system of claim 4, wherein the input of (a) includes one or more design goals selected from the group consisting of: assigning about the same number of work hours for each worker during a work period, assigning each worker an equal number of on-days for a particular day of the week over the work cycle, and assigning each worker an equal number of off-days for a particular day of the week over the work cycle.

6. The scheduling system of claim 4, wherein the input of (a) includes one or more design constraints selected from the group consisting of: a coverage quota, an overtime limit, and a contiguity limit.

7. The scheduling system of claim 1, wherein the indication of the subteam assignments to the off-days is displayed on the graphical user interface of the output device in a calendar format.

8. The scheduling system of claim 7, wherein the graphical user interface is configurable to alternately display the indication of the subteam assignments to the off-days for (i) all subteams and (ii) a single subteam.

9. The scheduling system of claim 1, wherein the number of subteams of each work team is six or seven.

10. The scheduling system of claim 1, wherein the work period is selected from the group consisting of: a week, a biweek, a semi-month, and a month.

11. The scheduling system of claim 1, wherein the workers are assigned to work teams and subteams by substantially evenly distributing workers that share a demographic factor among the work teams and the subteams.

12. The scheduling system of claim 1, the steps of (d) further comprising: detecting, by the processor, when a contiguity limit is met.

13. The scheduling system of claim 1, wherein the displayed subteam assignments are configured to allow visual verification of a design goal.

14. The scheduling system of claim 1, wherein the displayed subteam assignments are configured to allow visual verification of a design constraint.

15. A computer-implemented method for providing a work schedule for workers in a workforce, the method comprising:
a) receiving an input, via an input device, the input including a list of workers qualified to perform one or more work tasks during a work shift;
b) communicating the input to a digital processor in communication with a permanent memory;
c) processing the input, by the digital processor, including the steps of:
i) counting a number of work shifts to be performed in a day by the workforce;
ii) determining a number of the workers to be assigned to the workforce, wherein the number of workers is twice the number of work shifts;
iii) assigning each of the workers in the workforce to one of two work teams, wherein each of the two work teams has about the same number of workers;
iv) dividing each of the two work teams into a number of subteams, wherein the number of subteams is a multiple of a number of off-days in a work period of a work cycle;
v) assigning the workers of the two work teams into the subteams, wherein each of the subteams has about the same number of the workers;
vi) assigning the two work teams to alternating primary work schedules of on-days and off-days within the work period;
vii) dividing the work cycle into standby cycles wherein each of the standby cycles is an integral number of work periods long;
viii) determining, for each standby cycle in the work cycle, an initial subteam number;
ix) for each work team and for each standby cycle in the work cycle, assigning one of the subteams to each off-day in a given standby cycle, based on the input received in (a); and
x) displaying an output in graphical form to a user, on an attached graphical user interface of an output device, the output including an indication of the subteam assignments to the off-days.

16. The method of claim 15, the steps of (c) further comprising:
in (ix), assigning one of the subteams to each off-day by steps comprising:
setting a first subteam number equal to the initial subteam number for the given standby cycle;
increasing the first subteam number by an increment for each subsequent off-day in the given standby cycle;
when the first subteam number is greater than the number of subteams, decreasing the first subteam number by the number of subteams;
assigning the subteams to the off-days of the given standby cycle according to the first subteam numbers; and
wherein the initial subteam number and the increment are based on the input received in (a).

17. The method of claim 15, the steps of (c) further comprising:
in (viii), determining the initial subteam number by steps comprising:
setting the initial subteam number equal to one for a first standby cycle;
increasing the initial subteam number by an index for each subsequent standby cycle; and
when the initial subteam number is greater than the number of subteams, decreasing the initial subteam number by the number of subteams.

18. The method of claim 15, the steps of (c) further comprising: detecting, by the processor, when a contiguity limit is met.
